(19) United States
(12) Patent Application Publication
(10) Pub. No.: US 2023/0367356 A1
(43) Pub. Date: Nov. 16, 2023

(54) DIGITAL SIGNAL PROCESSING DEVICE AND METHOD OF CALCULATING SOFTMAX PERFORMED BY THE SAME

(71) Applicant: SAMSUNG ELECTRONICS CO., LTD., Suwon-si (KR)

(72) Inventor: Soobok Yeo, Suwon-si (KR)

(73) Assignee: SAMSUNG ELECTRONICS CO., LTD., Suwon-si (KR)

(21) Appl. No.: 18/140,435

(22) Filed: Apr. 27, 2023

(30) Foreign Application Priority Data
May 12, 2022 (KR) 10-2022-0058591

(51) Int. Cl. G06F 1/03; G06F 7/556; G06F 7/523; G06F 5/01

(52) U.S. Cl. CPC G06F 1/0307; G06F 5/01; G06F 7/523; G06F 7/556

(57) ABSTRACT

A digital signal processing device is provided. The digital signal processing devices includes: a processor configured to execute instructions to implement: a lookup table generator configured to generate a first lookup table corresponding to a first exponential function, based on an input scaling value; and a softmax calculator configured to receive input data indicating input values, calculate a first index of the first lookup table, the first index corresponding to a first input value of the input values, read a first exponential function value corresponding to the first index from the first lookup table, calculate a first intermediate value based on the first exponential function value and the first input value, and generate output data indicating output values respectively corresponding to the input values, wherein a first output value of the output values is generated based on the first intermediate value.

### CROSS-REFERENCE TO RELATED APPLICATION

This application is based on and claims priority to Korean Patent Application No. 10-2022-0058591, filed on May 12, 2022, in the Korean Intellectual Property Office, the disclosure of which is incorporated by reference herein in its entirety.

### BACKGROUND

The present disclosure relates to a digital signal processing device for performing a softmax calculation, and more particularly, to a digital signal processing device for performing a softmax calculation based on a lookup table.

A neural network may be implemented with reference to a computational architecture. With the recent development of neural network technology, research on analyzing input data and extracting valid information by using a neural network in various types of electronic systems is being actively conducted.

A softmax calculation may be used for multiple classification in the final layer of the neural network. In addition, a recurrent neural network (RNN) used for speech recognition may use the softmax calculation as one type of activation function. However, the softmax calculation includes an exponential function calculation, and thus, which requires time and system resources to perform calculations. Therefore, it is necessary to develop a method of performing a faster softmax calculation which uses fewer system resources, while maintaining the accuracy of the softmax calculation.

### SUMMARY

One or more embodiments provide a digital signal processing device for performing a faster softmax calculation with high accuracy.

According to an aspect of an embodiment, a digital signal processing devices includes: one or more memories storing instructions; and one or more processors configured to execute the instructions to implement: a lookup table generator configured to generate a first lookup table corresponding to a first exponential function, based on an input scaling value; and a softmax calculator configured to receive input data indicating a plurality of input values, calculate a first index of the first lookup table, the first index corresponding to a first input value of the plurality of input values, read a first exponential function value corresponding to the first index from the first lookup table, calculate a first intermediate value based on the first exponential function value and the first input value, and generate output data indicating a plurality of output values respectively corresponding to the plurality of input values, wherein a first output value of the plurality of output values is generated based on the first intermediate value.

According to an aspect of an embodiment, a softmax calculation method, which is performed by a digital signal processing device, is provided. The softmax calculation method includes: receiving an input scaling value and input data indicating a plurality of input values; generating a first lookup table corresponding to a first exponential function, based on the input scaling value; calculating a first index of the first lookup table, the first index corresponding to a first input value of the plurality of input values; reading a first exponential function value corresponding to the first index from the first lookup table; calculating a first intermediate value based on the first exponential function value; and generating output data indicating a plurality of output values respectively corresponding to the plurality of input values, wherein a first output value of the plurality of output values is generated based on the first intermediate value.

According to an aspect of an embodiment, a digital signal processing device includes: one or more memories storing instructions; and one or more processors configured to execute the instructions to implement: a first lookup table generator configured to generate a first lookup table corresponding to a first exponential function, based on an input scaling value; a second lookup table generator configured to generate a second lookup table corresponding to a second exponential function, based on the input scaling value and a size of the first lookup table; a softmax calculator configured to receive input data indicating a plurality of input values, calculate a first index of the first lookup table and a second index of the second lookup table, the first index and the second index each corresponding to a first input value of the plurality of input values, read a first exponential function value corresponding to the first index from the first lookup table, read a second exponential function value corresponding to the second index from the second lookup table, calculate a first intermediate value based on the first exponential function value and the second exponential function value, and generate output data indicating a plurality of output values respectively corresponding to the plurality of input values, wherein a first output value of the plurality of output values is generated based on the first intermediate value; and a type converter configured to convert a data type of the output data.

### BRIEF DESCRIPTION OF THE DRAWINGS

The above and other aspects and features will be more apparent from the following description of embodiments taken in conjunction with the accompanying drawings, in which:

FIG. 1 is a block diagram illustrating a digital signal processing device according to an embodiment;

FIG. 2 is a flowchart illustrating a softmax calculation method according to an embodiment;

FIG. 3 is a flowchart illustrating a method of generating a first lookup table by a digital signal processing device, according to an embodiment;

FIG. 4 is a flowchart illustrating a method of calculating a first index by a digital signal processing device, according to an embodiment;

FIG. 5 is a diagram illustrating a softmax calculation process by a digital signal processing device, according to an embodiment;

FIG. 6 is a block diagram illustrating a digital signal processing device according to another embodiment;

FIG. 7 is a flowchart illustrating a softmax calculation method according to another embodiment;

FIG. 8 is a diagram illustrating a softmax calculation process by a digital signal processing device, according to another embodiment;

FIG. 9 is a diagram illustrating a process of converting output data into a quantized integer type by a digital signal processing device, according to an embodiment;

FIG. 10 is a diagram illustrating an example of a neural network, according to an embodiment;

FIG. 11 is a block diagram illustrating a hardware configuration of a neural network device, according to an embodiment; and

FIG. 12 is a diagram illustrating a neural network for classification, according to an embodiment.

### DETAILED DESCRIPTION

Hereinafter, embodiments will be described more fully with reference to the accompanying drawings. Embodiments described herein are provided as examples, and thus, the present disclosure is not limited thereto, and may be realized in various other forms. Each embodiment provided in the following description is not excluded from being associated with one or more features of another example or another embodiment also provided herein or not provided herein but consistent with the present disclosure. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

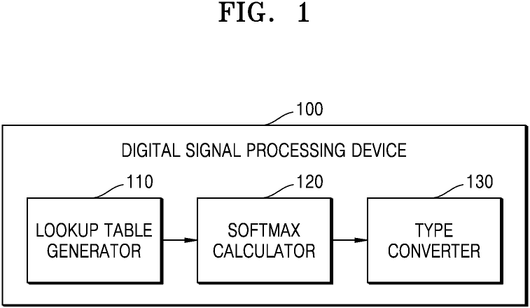

FIG. 1 is a block diagram illustrating a digital signal processing device according to an embodiment.

Referring to FIG. 1, a digital signal processing device 100 may include a lookup table generator 110, a softmax calculator 120, and a type converter 130.

The lookup table generator 110 may generate a lookup table that may be used to quickly perform calculations of an exponential function required for a softmax calculation.

The lookup table generator 110 may receive an input scaling value. The input scaling value may be used for quantization of a plurality of input values. A scaling value of input data may be determined during a quantization process of the input data. The input data may be received by the softmax calculator 120 described below.

The lookup table generator 110 may generate a first lookup table based on an input scaling value. The first lookup table may be a lookup table in which calculation results of a first exponential function are stored. The first lookup table may have input values of the first exponential function as an index and output values of the first exponential function as values corresponding to the index.

The softmax calculator 120 may receive input data including a plurality of input values. The plurality of input values may be integers of a quantized data type, and an input scaling value may be calculated in a process in which the plurality of input values are quantized.

The softmax calculator 120 may perform a softmax calculation on a plurality of input values to generate output data including a plurality of output values. By the softmax calculation, the plurality of input values may be normalized to values between 0 and 1 and converted into a plurality of output values of which the sum is 1, which may be represented by Equation 1 below.

$${y}_{k} = \frac{{e}^{{x}_{k}}}{{\sum }_{m = 0 \sim \left(K - 1\right)} {e}^{{x}_{m}}} , w h e r e \text{k} = 0 , … , \left(\text{K} - 1\right) \qquad \text{Equation 1:}$$

In Equation 1, xₖ may represent an input value and yₖ may represent an output value. As described above, the softmax calculation includes an exponential function calculation and a division calculation, thereby taking a lot of time and processing resources, and thus, there is a need to develop a faster processing method which uses fewer system resources.

The softmax calculator 120 may calculate a plurality of intermediate values respectively corresponding to a plurality of input values based on the first lookup table. In this case, the softmax calculator 120 may calculate a first index of the first lookup table, the first index corresponding to the input value, may read a first exponential function value corresponding to the first index from the first lookup table, and may calculate an intermediate value based on the first exponential function value. In addition, the softmax calculator 120 may generate a plurality of output values based on the plurality of intermediate values.

As described above, the digital signal processing device 100 according to an embodiment may perform a softmax calculation by using a lookup table without directly calculating an exponential function, and thus, a faster softmax calculation may be performed using fewer system resources.

The type converter 130 may convert a data type of output data. The type converter 130 may convert the data type of output data to be suitable for a data type required by a device that receives the output data.

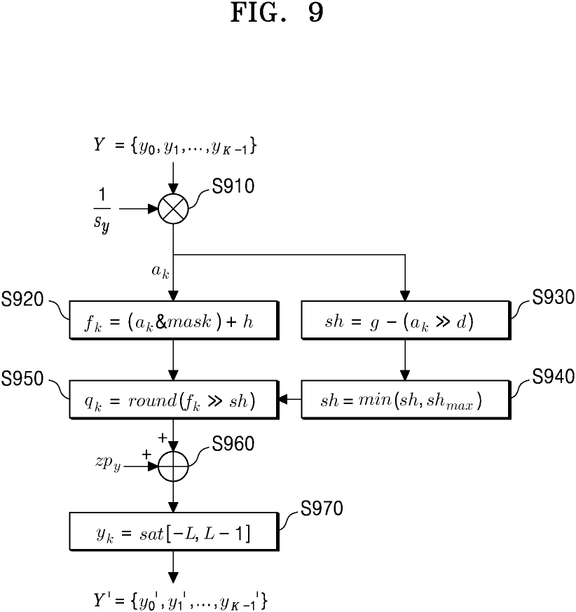

In an embodiment, the type converter 130 may convert the data type of output data into a quantized integer type, based on an output scaling value and an output zero value. This is described in more detail with reference to FIG. 9.

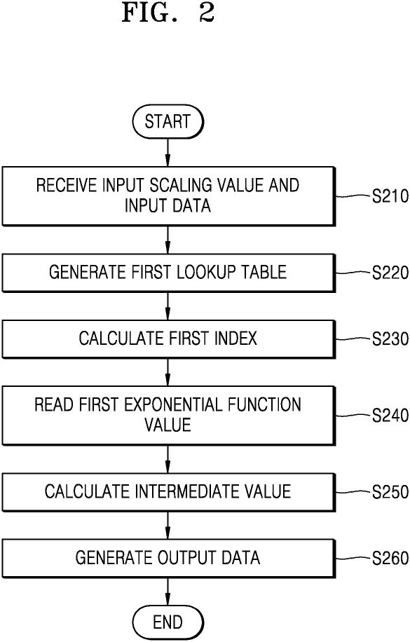

FIG. 2 is a flowchart illustrating a softmax calculation method according to an embodiment.

Referring to FIG. 2, in operation S210, the digital signal processing device 100 may receive an input scaling value and input data. In this case, the input data may include a plurality of input values. Hereinafter, the input scaling value may be represented as sₓ, the input data may be represented as X, and a plurality of input values may be represented as x₀ to x_{K-1}.

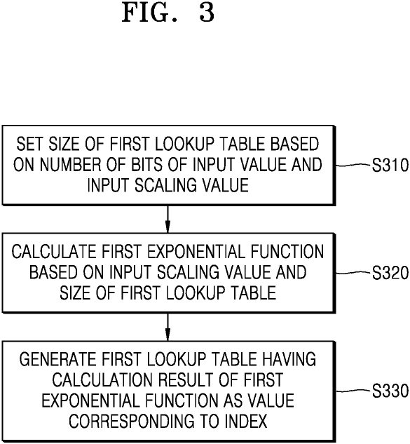

In operation S220, the digital signal processing device 100 may generate the first lookup table through the lookup table generator 110. A more detailed method of generating the first lookup table is described in more detail with reference to FIG. 3.

FIG. 3 is a flowchart illustrating a method of generating the first lookup table by a digital signal processing device, according to an embodiment.

Referring to FIG. 3, a flowchart illustrating a more detailed process of operation S220 of FIG. 2 is shown.

First, in operation S310, the lookup table generator 110 may set a size of the first lookup table, based on the number of bits of an input value and an input scaling value. In this case, the size of the first lookup table may be the same as the number of indexes included in the first lookup table.

In an embodiment, the size of the first lookup table may be set to a smaller number of the smallest integer greater than or equal to a reciprocal number of the input scaling value or the total amount of numbers representable using the number of bits of each of a plurality of input values. This may be represented by Equation 2 and Equation 3 below.

$$\text{N} = min \left({N}_{1} , {2}^{M}\right) \qquad \text{Equation 2:}$$

$$\frac{1}{{s}_{x}} \leq {N}_{1} , w h e r e \text{N is integer} \qquad \text{Equation 3:}$$

In Equation 2 and Equation 3, N may represent the size of the first lookup table, N1 may represent the smallest integer greater than or equal to the reciprocal number of the input scaling value, and M may represent the number of bits of the input value.

In operation S320, the lookup table generator 110 may calculate a first exponential function, based on the input scaling value and the size of the first lookup table. The lookup table generator 110 may calculate the first exponential function by using 0 to N-1, which are indexes included in the first lookup table, as input values of the first exponential function. The first exponential function may be calculated by using Equation 4 below.

$${e}^{\left(b - \left(N - 1 - u\right) ⋅ {s}_{x}\right)} \qquad \text{Equation 4:}$$

In Equation 4, b may represent an offset value, and u may represent the input value of the first exponential function. The offset value b is a value that does not affect final output data of the digital signal processing device 100 and may be set to any value for reducing complexity of an exponential function calculation.

The first exponential function calculation in operation S320 may be performed by using any one of various methods, such as a Taylor series expansion.

In operation S330, the lookup table generator 110 may generate the first lookup table having a calculation result of the first exponential function as a value corresponding to an index.

The lookup table generator 110 may generate the first lookup table to have calculation results of the first exponential function corresponding to 0 to N-1, which are indexes of the first lookup table, as values respectively corresponding to the indexes. The first lookup table may be represented by Equation 5 below.

$$\text{LUT1} \left(\text{u}\right) = {e}^{\left(b - \left(N - 1 - u\right) ⋅ {s}_{x}\right)} , w h e r e \text{u} = 0 , … , \left(\text{N} - 1\right) \qquad \text{Equation 5:}$$

In Equation 5, u may represent an index of the first lookup table, and LUT1(u) may represent a value of the first lookup table corresponding to the index u.

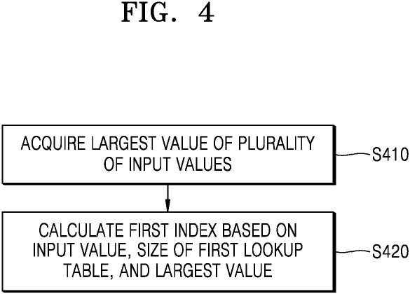

Referring back to FIG. 2, in operation S230, the digital signal processing device 100 may calculate a first index of the first lookup table, the first index corresponding to an input value through the softmax calculator 120. A more detailed method of calculating the first index is described with reference to FIG. 4.

FIG. 4 is a flowchart illustrating a method of calculating a first index by a digital signal processing device, according to an embodiment.

Referring to FIG. 4, a flowchart illustrating a more detailed process of operation S230 of FIG. 2 is shown.

First, in operation S410, the softmax calculator 120 may acquire a largest value of a plurality of input values. The softmax calculator 120 may compare a plurality of input values, x₀ to x_{K-1}, and acquire one of the plurality of input values as the largest value as Xmax.

In operation S420, the softmax calculator 120 may calculate a first index corresponding to an input value based on the input value, the size of the first lookup table, and the largest value. In this case, the first index may be calculated by Equation 6 below, and w included in Equation 6 may be calculated by Equation 7 below.

$$\text{u} = mod \left(\text{w, N}\right) \qquad \text{Equation 6:}$$

$$\text{w} = \left(\text{N} - 1 - {x}_{m a x} + {x}_{k}\right) , w h e r e \text{k} = 0 , … , \left(\text{K} - 1\right) \qquad \text{Equation 7:}$$

Referring back to FIG. 2, in operation S240, the softmax calculator 120 may read a first exponential function value corresponding to the first index from the first lookup table. As described above, the softmax calculator 120 may use a lookup table without directly calculating an exponential function, and thus, the required calculation time may be reduced and fewer system resources may be used.

In operation S250, the softmax calculator 120 may calculate an intermediate value based on the first exponential function value. In this case, the intermediate value may be calculated by using Equation 8 below, and v included in Equation 8 may be calculated by Equation 9 below.

$${z}_{k} = L U T 1 \left(u\right) ⋅ {e}^{- v ⋅ N ⋅ {s}_{x}} , w h e r e \text{k} = 0 , … , \left(\text{K} - 1\right) \qquad \text{Equation 8:}$$

$$\text{v} = \text{ceil} \left(- \frac{w}{N}\right) \qquad \text{Equation 9:}$$

In Equation 8, zₖ may represent an intermediate value calculated based on an input value xₖ, and v may represent a second index of a second lookup table to be described below.

Operations S230 to S250 described above may all be performed for each of a plurality of input values, and thus, a plurality of intermediate values respectively corresponding to the plurality of input values may be calculated.

In operation S260, the softmax calculator 120 may generate output data. The softmax calculator 120 may generate output data including a plurality of output values based on the plurality of intermediate values respectively corresponding to the plurality of input values. In this case, the output values may be calculated by Equation 10 below.

$${y}_{k} = \frac{{z}_{k}}{{\sum }_{m = 0 \sim \left(K - 1\right)} {z}_{m}} , w h e r e \text{k} = 0 , … , \left(\text{K} - 1\right) \qquad \text{Equation 10:}$$

In Equation 10, yₖ may be an output value corresponding to the input value xₖ and the intermediate value zₖ.

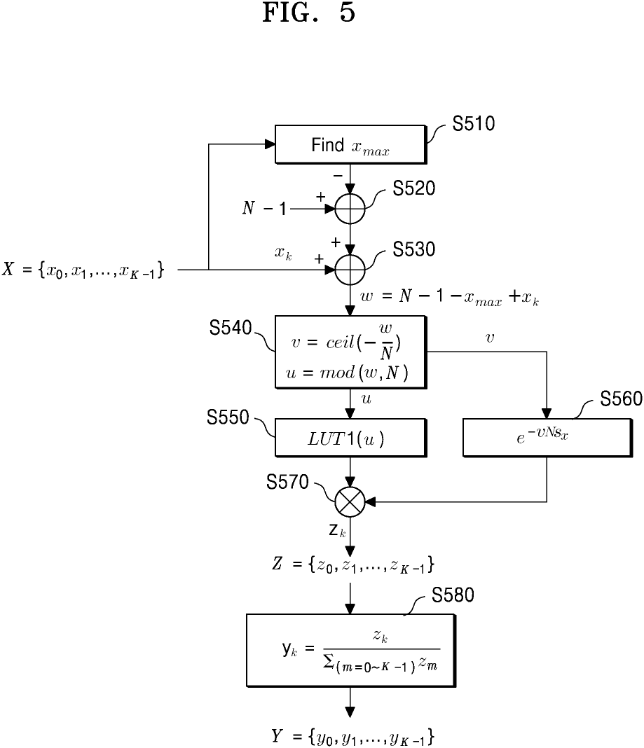

FIG. 5 is a diagram illustrating a softmax calculation process by a digital signal processing device, according to an embodiment.

Referring to FIG. 5, in operation S510, the softmax calculator 120 may receive a plurality of input values X and find the largest value xₘₐₓ of the plurality of input values X.

In operation S520, the softmax calculator 120 may subtract the largest value xₘₐₓ from the value obtained by subtracting 1 from a size N of the lookup table.

In operation S530, the softmax calculator 120 may calculate w by adding any one xₖ of the plurality of input values X to a calculation result of operation S520.

In operation S540, the softmax calculator 120 may calculate a first index u and a second index v, based on w calculated in operation S530 and the size N of the lookup table.

Here, operation S510 to operation S540 may correspond to operation S230 of FIG. 2. In addition, operation S510 may correspond to operation S410 of FIG. 4, and operation S520 to operation S540 may correspond to operation S420 of FIG. 2.

In operation S550, the softmax calculator 120 may read a first exponential function value corresponding to the first index from the first lookup table. Operation S550 may correspond to operation S240 of FIG. 2.

In operation S560, the softmax calculator 120 may calculate an exponential function, based on v calculated in operation S540, the size N of the lookup table, and an input scaling value sₓ.

In operation S570, the softmax calculator 120 may calculate the intermediate value zₖ by multiplying the read result in operation S550 by the calculation result in operation S560.

In this case, operation S530 to operation S570 may all be performed for each of the plurality of input values X, and thus, a plurality of intermediate values Z respectively corresponding to the plurality of input values X may be calculated.

Here, operation S560 and operation S570 may correspond to operation S250 of FIG. 2.

In operation S580, the softmax calculator 120 may calculate each output value by dividing each intermediate value by the sum of a plurality of intermediate values Z. The calculation of operation S580 may be performed for all intermediate values, and thus, a plurality of output values Y may be calculated. Operation S580 may correspond to operation S260 of FIG. 2.

As described above, the softmax calculator 120 of the digital signal processing device 100 according to an embodiment may calculate some of the exponential functions required for a softmax calculation based on the first lookup table, and thus, a faster softmax calculation may be performed with high accuracy and using fewer system resources.

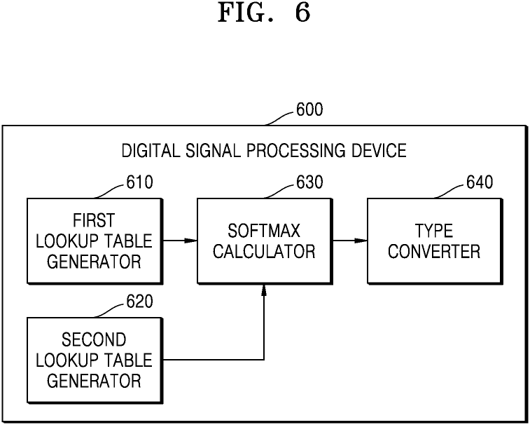

FIG. 6 is a block diagram illustrating a digital signal processing device according to another embodiment.

Referring to FIG. 6, a digital signal processing device 600 may include a first lookup table generator 610, a second lookup table generator 620, a softmax calculator 630, and a type converter 640.

The first lookup table generator 610 and the second lookup table generator 620 may generate a lookup table that may be used to quickly calculate an exponential function required for a softmax calculation using a reduced amount of system resources.

Although FIG. 6 illustrates an embodiment in which the first lookup table generator 610 and the second lookup table generator 620 are configured as separate blocks, embodiments are not limited thereto, and the first lookup table generator 610 and the second lookup table generator 620 may also be configured as one block.

The first lookup table generator 610 may generate a first lookup table based on an input scaling value. The first lookup table generator 610 may perform the same operation as the lookup table generator 110 of FIG. 1.

The second lookup table generator 620 may receive an input scaling value and the size of the first lookup table.

The second lookup table generator 620 may generate a second lookup table, based on the input scaling value and the size of the first lookup table. The second lookup table may include a lookup table in which calculation results of a second exponential function are stored. The second lookup table may have input values of the second exponential function as an index and may have output values of the second exponential function as values corresponding to the index.

The softmax calculator 630 may receive input data including a plurality of input values. The softmax calculator 630 may perform a softmax calculation on a plurality of input values to generate output data including a plurality of output values.

The softmax calculator 630 may calculate a plurality of intermediate values respectively corresponding to the plurality of input values, based on the first lookup table and the second lookup table. In this case, the softmax calculator 630 may calculate a first index of the first lookup table and a second index of the second lookup table, the first index and the second index each corresponding to one of the plurality of input values, read a first exponential function value corresponding to the first index from the first lookup table, read a second exponential function value corresponding to the second index from the second lookup table, and calculate an intermediate value, based on the first exponential function value and the second exponential function value. In addition, the softmax calculator 630 may generate a plurality of output values based on a plurality of intermediate values.

As described above, the digital signal processing device 600 according to another embodiment may perform a softmax calculation by using a lookup table without directly calculating an exponential function, and thus, a faster softmax calculation may be performed using fewer system resources.

The type converter 640 may perform the same operation as the type converter 130 of FIG. 1.

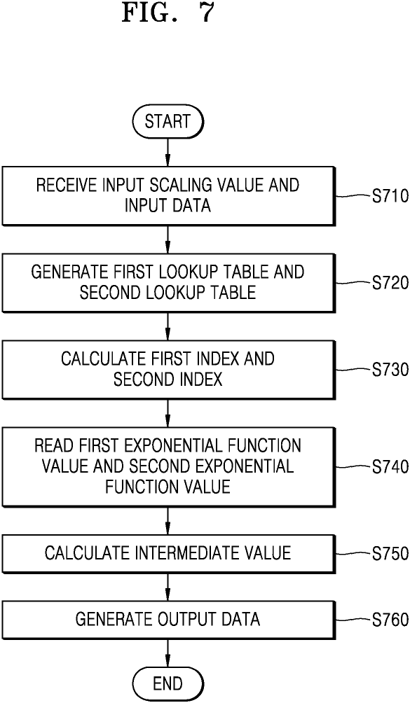

FIG. 7 is a flowchart illustrating a softmax calculation method according to another embodiment.

Referring to FIG. 7, in operation S710, the digital signal processing device 600 may receive an input scaling value and input data.

In operation S720, the digital signal processing device 600 may generate a first lookup table through the first lookup table generator 610 and a second lookup table through the second lookup table generator 620.

The first lookup table generator 610 may generate the first lookup table in the same manner as described above with reference to FIGS. 2 and 3.

When an index of the second lookup table is greater than or equal to a preset reference index, the second lookup table generator 620 may generate the second lookup table such that a calculation result of the second exponential function corresponding to the index of the second lookup table is 0. For example, when the reference index is 10, a value corresponding to an index of the second lookup table that is greater than or equal to 10 may be set to 0.

The second lookup table generator 620 may set a value corresponding to the index of the second lookup table, which is less than the reference index, by calculating the second exponential function.

The second lookup table generator 620 may calculate the second exponential function by using the index, which is less than the reference index, as an input value of the second exponential function. The first exponential function may be calculated by using Equation 11 below.

$${e}^{\left(- n ⋅ N ⋅ {s}_{x}\right)} \qquad \text{Equation 11:}$$

In Equation 11, n may represent an input value of the second exponential function.

The second lookup table generator 620 may generate the second lookup table that has a calculation result of the second exponential function as a value corresponding to an index less than the reference index and has 0 as a value corresponding to an index greater than or equal to the reference index.

The second lookup table generator 620 may generate the second lookup table by setting the size of the second lookup table to a value that is one greater than the reference index to save memory.

In operation S730, the digital signal processing device 600 may calculate a first index of the first lookup table and a second index of the second lookup table, the first index and the second index each corresponding to an input value, through the softmax calculator 630.

A method in which the softmax calculator 630 calculates the first index may be the same as described above with reference to FIGS. 2 and 3.

The softmax calculator 630 may calculate the second index corresponding to the input value, based on the input value, the size of the first lookup table, and a largest value. In this case, the second index may be calculated by Equation 9, and w included in Equation 9 may be calculated by Equation 7 above. That is, v in Equation 9 may be used as the second index.

In operation S740, the softmax calculator 630 may read a first exponential function value corresponding to the first index from the first lookup table and a second exponential function value corresponding to the second index from the second lookup table. As described above, the softmax calculator 630 may use a lookup table without directly calculating an exponential function, and thus, the required calculation time may be reduced and fewer system resources may be used.

In operation S750, the softmax calculator 630 may calculate an intermediate value, based on the first exponential function value and the second exponential function value. In this case, the softmax calculator 630 may calculate the intermediate value by multiplying the first exponential function value by the second exponential function value, and the intermediate value may be represented by Equation 12 below.

$${z}_{k} = L U T 1 \left(u\right) ⋅ L U T 2 \left(v\right) \qquad \text{Equation 12:}$$

In Equation 12, zₖ may be the intermediate value. LUT1(u) may indicate a value of the first lookup table corresponding to an index u. LUT1(v) may indicate a value of the second lookup table corresponding to an index v.

As described above, the exponential function included in Equation 8 may be calculated through the second lookup table, and thus, a faster calculation may be performed using fewer system resources.

Operation S730 to operation S750 described above may all be performed for each of a plurality of input values, and thus, a plurality of intermediate values respectively corresponding to the plurality of input values may be calculated.

In operation S760, the softmax calculator 630 may generate output data. The softmax calculator 630 may generate output data including a plurality of output values based on the plurality of intermediate values respectively corresponding to the plurality of input values. Operation S760 may be the same as operation S260 of FIG. 2.

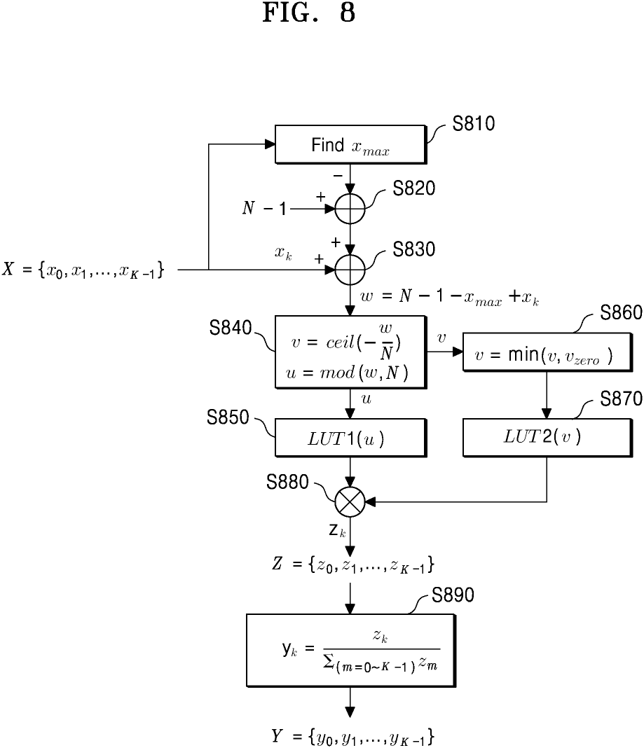

FIG. 8 is a diagram illustrating a softmax calculation process by a digital signal processing device, according to another embodiment.

Referring to FIG. 8, in operation S810, the softmax calculator 630 may receive a plurality of input values X and find a largest value xₘₐₓ of the plurality of input values X.

In operation S820, the softmax calculator 630 may subtract the largest value xₘₐₓ from a value obtained by subtracting 1 from a size N of a lookup table.

In operation S830, the softmax calculator 120 may calculate w by adding any one xₖ of the plurality of input values X to a calculation result of operation S820.

In operation S840, the softmax calculator 630 may calculate a first index u and a second index v, based on w calculated in operation S830 and the size N of the lookup table.

Here, operation S810 to operation S840 may correspond to operation S730 of FIG. 7.

In operation S850, the softmax calculator 630 may read a first exponential function value corresponding to the first index u from a first lookup table.

In operation S860, the softmax calculator 630 may calculate the second index v by using the smaller value of the second index v calculated in operation S840 and a reference index. This is because, when the second lookup table generator 620 sets the size of a second lookup table to a value greater than the reference index by 1 to save memory, and the second index v exceeds the reference index, there is no value corresponding to the second lookup table.

In operation S870, the softmax calculator 630 may read a second exponential function value corresponding to the second index v from the second lookup table.

Here, operation S850 to operation S870 may correspond to operation S740 of FIG. 7.

In operation S880, the softmax calculator 630 may calculate an intermediate value zₖ by multiplying the read result of operation S850 by the read result of operation S870.

In this case, operation S830 to operation S880 may all be performed for each of the plurality of input values X, and thus, a plurality of intermediate values Z respectively corresponding to the plurality of input values X may be calculated.

Here, operation S880 may correspond to operation S750 of FIG. 7.

In operation S890, the softmax calculator 630 may calculate each output value by dividing each intermediate value by the sum of the plurality of intermediate values. The calculation of operation S890 may be performed for all intermediate values, and thus, a plurality of output values Y may be calculated. Operation S890 may correspond to operation S760 of FIG. 7.

As described above, the softmax calculator 630 of the digital signal processing device 100 according to another embodiment may calculate exponential functions necessary for a softmax calculation based on the first lookup table and the second lookup table, and thus, a faster softmax calculation may be performed with high accuracy and using fewer system resources.

FIG. 9 is a diagram illustrating a process of converting output data into a quantized integer type by a digital signal processing device, according to an embodiment.

Referring to FIG. 9, in operation S910, the type converter 130 may multiply a plurality of output values y₀, ..., y_{K-1} by a reciprocal number of an output parameter value s_{y} before conversion.

In more detail, the type converter 130 may first receive output data Y including the plurality of output values y₀, ..., y_{K-1} from the softmax calculator 120. In this case, the data type of the plurality of output values y₀, ..., y_{K-1} received from the softmax calculator 120 may be a floating point type. The type converter 130 may multiply the plurality of output values y₀, ..., y_{K-1} of the floating point type by the reciprocal number of the output parameter value s_{y}. The output parameter value s_{y} may be used to adjust scales of the plurality of output values y₀, ..., y_{K-1} and may be determined according to a distribution of the plurality of output values y₀, ..., y_{K-1}.

In operation S920, the type converter 130 may perform a calculation based on a value aₖ, which is the output of operation S910. The type converter 130 may perform an AND operation on the value aₖ and a mask value and add a value h to the value obtained by the AND operation. In this case, when the output values before conversion are values of a half-precision type (FP16), the mask value may be 0×3FF, and the value h may be 0×400. When the output values before conversion are values of a single-precision type (FP32), the mask value may be 0×7FFFFFFF, and the value h may be 0×800000.

In operation S930, the type converter 130 may perform a calculation based on the value aₖ, which is an output of operation S910. The type converter 130 may shift the value aₖ to the left by a value d and subtract the shifted result from a value g. In this case, when the output values before conversion are values of the half-precision type (FP16), the value d may be 10 and the value g may be 25. When the output values before conversion are values of the single-precision type (FP32), the value d may be 23, and the value g may be 150.

In operation S940, the type converter 130 may compare a value sh, which is an output in operation S910, with a value shₘₐₓ and reset the smaller value of the values as the value sh. In this case, when the output values before conversion are values of the half-precision type (FP16), the value shₘₐₓ may be 15. When the output values before conversion are values of the single-precision type (FP32), the value shₘₐₓ may be 31.

In operation S950, the type converter 130 may perform a calculation based on a value fₖ, which is an output of operation S920, and the value sh, which is an output of operation S940. The type converter 130 may calculate an integer value qₖ by shifting the value fₖ to the left by the value sh and rounding the shifted value.

In operation S960, the type converter 130 may add an output zero-point value zp_{y} to the value qₖ, which is the output of operation S950. The output zero-point value may be used to adjust an average of quantization results of the plurality of output values and may be determined according to a distribution of the plurality of output values.

Finally, in operation S970, the type converter 130 may distribute an output of operation S960 to have an integer value between -L and L-1. Output data Y′ including a plurality of output values y₀′, ..., y_{K-1}′, which are integers of a quantized data type, may be generated as an output of operation S970.

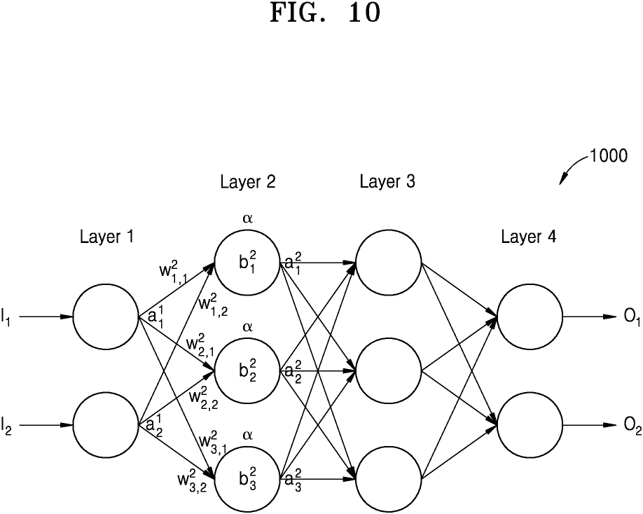

FIG. 10 is a diagram illustrating an example of a neural network, according to an embodiment.

Referring to FIG. 10, an example of a neural network 1000 is illustrated. The neural network 1000 may include an input layer, hidden layers, and an output layer, perform a calculation based on received input data (for example, I₁ and I₂), and generate output data (for example, O₁ and O₂) based on the calculation result.

The neural network 1000 may be composed of a deep neural network (DNN) including one or more hidden layers or may be composed of an n-layers neural network. For example, as illustrated in FIG. 10, the neural network 1000 may be composed of a DNN including an input layer Layer 1, two hidden layers Layer 2 and Layer 3, and an output layer Layer 4. The DNN may include, for example, convolutional neural networks (CNN), recurrent neural networks (RNN), deep belief networks, or restricted Boltzmann machines, but is not limited thereto.

When the neural network 1000 has a DNN structure, more layers from which valid information may be extracted may be included therein, and thus, the neural network 1000 may process more complex data sets than a related neural network. In addition, although the neural network 1000 is illustrated as including four layers, this is only an example, and the neural network 1000 may include fewer or more layers. In addition, the neural network 1000 may include layers having various structures different from the structure illustrated in FIG. 10. For example, the neural network 1000 may include a convolution layer, a pooling layer, and a fully connected layer as a DNN.

Each of the layers included in the neural network 1000 may include a plurality of artificial nodes, each of which may be referred to as a “neuron”, a “processing element (PE)”, a “unit”, or other similar term. For example, as illustrated in FIG. 1, Layer 1 may include two nodes, and Layer 2 may include three nodes. However, this is only an example, and each of the layers included in the neural network 1000 may include multiple nodes.

Nodes included in each of the layers included in the neural network 1000 may be connected to each other to exchange data. For example, one node may perform a calculation by receiving data from another node and may output the calculation result to the other nodes.

An output value of each of the nodes may be referred to as an activation. The activation may be an output value of one node and may be input values of nodes included in the next layer. In addition, each of the nodes may determine its own activation based on activations and weights received from nodes included in the previous layer. A weight is a parameter used to calculate an activation of each node and may be a value assigned to a connection relationship between nodes.

Each of the nodes may receive an input and output an activation, and may map an input to an output.

In the neural network 1000, numerous data sets are exchanged between a plurality of interconnected channels and undergo numerous calculation processes while passing through layers. One of the numerous calculations may be the softmax calculation. By using the digital signal processing device according to embodiments for the softmax calculation, a faster softmax calculation may be performed with high accuracy and using fewer system resources.

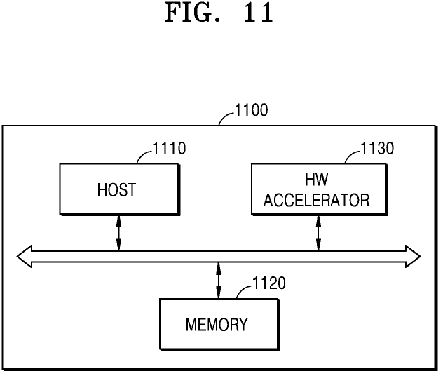

FIG. 11 is a block diagram illustrating a hardware configuration of a neural network device, according to an embodiment.

Referring to FIG. 11, a neural network device 1100 according to an embodiment may include a host 1110, a memory 1120, and a hardware accelerator 1130. FIG. 11 only illustrates main components of the neural network device 1100. Therefore, the neural network device 1100 may further include other components in addition to the components illustrated in FIG. 11.

The neural network device 1100 corresponds to a computing device having various processing functions, such as a function for generating a neural network, a function for training (or learning) a neural network, a function for quantizing a floating-point type neural network into a fixed-point type neural network, and a function for retraining a neural network. For example, the neural network device 1100 may be implemented by various types of devices, such as a personal computer (PC), a server device, and a mobile device.

The host 1110 may perform all functions for controlling the neural network device 1100. For example, the host 1110 may generally control the neural network device 1100 by executing programs stored in the memory 1120 of the neural network device 1100. The host 1110 may be implemented by, for example, a central processing unit (CPU), a graphics processing unit (GPU), or an application processor (AP) included in the neural network device 1100, but is not limited thereto.

The host 1110 may generate a neural network for classification and may train the neural network for classification. The neural network for classification may output a calculation result on which class input data corresponds to among classes. Specifically, the neural network for classification may output a calculation result on the possibility that input data corresponds to each of the classes as a result value on each of the classes. In addition, the neural network for classification may include a softmax layer and a loss layer. The softmax layer may convert a result value on each of the classes into a probability value, and the loss layer may calculate a loss as an objective function for learning. In this case, the softmax layer may perform a calculation by using the digital signal processing device according to embodiments.

The memory 1120 is hardware in which various types of data processed by the neural network device 1100 are stored, and for example, the memory 1120 may store data processed by the neural network device 1100 and data to be processed thereby. In addition, the memory 1120 may store applications and drivers to be driven by the neural network device 1100. The memory 1120 may include dynamic random access memory (DRAM) but is not limited thereto. The memory 1120 may include at least one of a volatile memory and a nonvolatile memory.

The neural network device 1100 may include a hardware accelerator 1130 that drives a neural network. The hardware accelerator 1130 may correspond to, for example, a neural processing unit (NPU), a tensor processing unit (TPU), or a neural engine, which are dedicated modules for driving a neural network, but is not limited thereto.

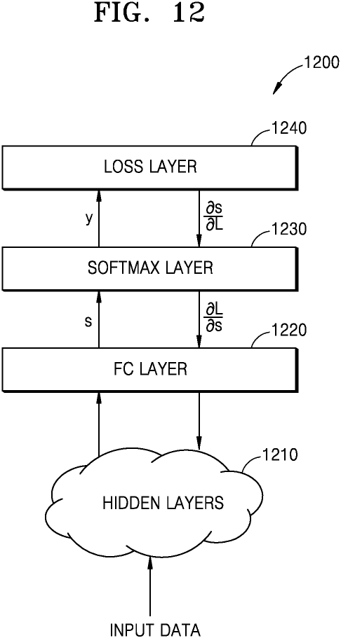

FIG. 12 is a diagram illustrating an embodiment of a neural network for classification.

Referring to FIG. 12, a neural network 1200 for classification according to an embodiment may include hidden layers 1210, a fully-connected (FC) layer 1220, a softmax layer 1230, and a loss layer 1240. Some of the hidden layers 1210 may include the FC layer, and the FC layer 1220 may include the last FC layer of the neural network 1200. In this regard, the FC layer 1220 may include a last-order FC layer among the FC layers of the neural network 1200.

When input data is input to the neural network 1200, the input data is sequentially calculated by the hidden layers 1210 and the FC layer 1220, and then the FC layer 1220 may output a calculation result s indicating the possibility that the input data is classified into each class. In this regard, the FC layer 1220 may output a result value on the possibility that the input data is classified into a corresponding class as the calculation result s for each of classes. Specifically, the FC layer 1220 may include nodes respectively corresponding to the classes and each of the nodes of the FC layer 1220 may output a result value on the possibility of being classified into each of the classes. For example, when the neural network is implemented for a classification task targeting five classes, an output value of each of first to fifth nodes of the FC layer may be a result value indicating the possibility that the input data is classified into each of first to fifth classes.

The FC layer 1220 may output the calculation result s to the softmax layer 1230, and the softmax layer 1230 may convert the calculation result s into a probability value y. In this regard, the softmax layer 1230 may generate the probability value y by normalizing the result value on the possibility that input data is classified into each class. In this case, the softmax layer 1230 may perform a calculation by using the digital signal processing device according to embodiments.

Next, the softmax layer 1230 may output the probability value y to the loss layer 1240, and the loss layer 1240 may calculate cross entropy loss of the calculation result s based on the probability value y. In this regard, the loss layer 1240 may calculate cross entropy loss indicating an error of the calculation result s.

In some embodiments, each of the components represented by a block as illustrated in FIGS. 1, 6 and 11 may be implemented as various numbers of hardware, software and/or firmware structures that execute respective functions described above, according to embodiments. For example, at least one of these components may include various hardware components including a digital circuit, a programmable or non-programmable logic device or array, an application specific integrated circuit (ASIC), transistors, capacitors, logic gates, or other circuitry using use a direct circuit structure, such as a memory, a processor, a logic circuit, a look-up table, etc., that may execute the respective functions through controls of one or more microprocessors or other control apparatuses. Also, at least one of these components may include a module, a program, or a part of code, which contains one or more executable instructions for performing specified logic functions, and executed by one or more microprocessors or other control apparatuses. Also, at least one of these components may further include or may be implemented by a processor such as a central processing unit (CPU) that performs the respective functions, a microprocessor, or the like. Functional aspects of embodiments may be implemented in algorithms that execute on one or more processors. Furthermore, the components, elements, modules or units represented by a block or processing steps may employ any number of related art techniques for electronics configuration, signal processing and/or control, data processing and the like.

While aspects of embodiments have been particularly shown and described, it will be understood that various changes in form and details may be made therein without departing from the spirit and scope of the following claims.

What is claimed is:

1. A digital signal processing device comprising:
one or more memories storing instructions; and
one or more processors configured to execute the instructions to implement:
a lookup table generator configured to generate a first lookup table corresponding to a first exponential function, based on an input scaling value; and
a softmax calculator configured to receive input data indicating a plurality of input values, calculate a first index of the first lookup table, the first index corresponding to a first input value of the plurality of input values, read a first exponential function value corresponding to the first index from the first lookup table, calculate a first intermediate value based on the first exponential function value and the first input value, and generate output data indicating a plurality of output values respectively corresponding to the plurality of input values, wherein a first output value of the plurality of output values is generated based on the first intermediate value .

2. The digital signal processing device of claim 1, wherein the lookup table generator is further configured to set a size of the first lookup table to a smaller number from among: a smallest integer greater than or equal to a reciprocal number of the input scaling value, and a total amount of numbers that are representable using a number of bits of the first input value.

3. The digital signal processing device of claim 2, wherein the lookup table generator is further configured to calculate the first exponential function based on the input scaling value and the size of the first lookup table, and generate the first lookup table having calculation results of the first exponential function as values corresponding to an index.

4. The digital signal processing device of claim 2, wherein the softmax calculator is further configured to acquire a largest value of the plurality of input values, and calculate the first index corresponding to the first input value, based on the first input value, the size of the first lookup table, and the largest value.

5. The digital signal processing device of claim 4, wherein the lookup table generator is further configured to generate a second lookup table corresponding to a second exponential function, based on the input scaling value and the size of the first lookup table.

6. The digital signal processing device of claim 5, wherein the lookup table generator is further configured to generate the second lookup table such that a calculation result of the second exponential function is 0, based on an index of the second lookup table being greater than or equal to a preset reference index.

7. The digital signal processing device of claim 5, wherein the softmax calculator is further configured to calculate a second index of the second lookup table, the second index corresponding to the first input value, read a second exponential function value corresponding to the second index from the second lookup table, and calculate the first intermediate value, based on the first exponential function value and the second exponential function value.

8. The digital signal processing device of claim 7, wherein the softmax calculator is further configured to calculate the second index corresponding to the first input value, based on the first input value, the size of the first lookup table, and the largest value.

9. The digital signal processing device of claim 7, wherein the softmax calculator is further configured to calculate the first intermediate value by multiplying the first exponential function value by the second exponential function value.

10. The digital signal processing device of claim 1, wherein the one or more processors are further configured to execute the instructions to implement a type converter configured to convert a data type of the output data.

11. The digital signal processing device of claim 10, wherein the type converter is further configured to convert the data type of the output data into a quantized integer type, based on an output scaling value and an output zero-point value.

12. A softmax calculation method, which is performed by a digital signal processing device, the softmax calculation method comprising:
receiving an input scaling value and input data indicating a plurality of input values;
generating a first lookup table corresponding to a first exponential function, based on the input scaling value;
calculating a first index of the first lookup table, the first index corresponding to a first input value of the plurality of input values;
reading a first exponential function value corresponding to the first index from the first lookup table;
calculating a first intermediate value based on the first exponential function value; and
generating output data indicating a plurality of output values respectively corresponding to the plurality of input values, wherein a first output value of the plurality of output values is generated based on the first intermediate value.

13. The softmax calculation method of claim 12, wherein the generating the first lookup table comprises:
setting, as a size of the first lookup table, a smaller number from among: a smallest integer greater than or equal to a reciprocal number of the input scaling value and a total amount of numbers representable using a number of bits of the first input value;
calculating the first exponential function, based on the input scaling value and the size of the first lookup table; and
generating the first lookup table having calculation results of the first exponential function as values corresponding to an index.

14. The softmax calculation method of claim 13, wherein the calculating the first index comprises:
acquiring a largest value of the plurality of input values; and
calculating the first index corresponding to the first input value, based on the first input value, the size of the first lookup table, and the largest value.

15. The softmax calculation method of claim 14, further comprising generating a second lookup table corresponding to a second exponential function, based on the input scaling value and the size of the first lookup table.

16. The softmax calculation method of claim 15, further comprising:
calculating a second index of the second lookup table, the second index corresponding to the first input value; and
reading a second exponential function value corresponding to the second index from the second lookup table,
wherein the calculating the first intermediate value comprises calculating the first intermediate value based on the first exponential function value and the second exponential function value.

17. The softmax calculation method of claim 16, wherein the calculating the second index comprises calculating the second index corresponding to the first input value, based on the first input value, the size of the first lookup table, and the largest value.

18. The softmax calculation method of claim 12, further comprising converting a type of the output data into a quantized integer type, based on an output scaling value and an output zero-point value.

19. A digital signal processing device comprising:
one or more memories storing instructions; and
one or more processors configured to execute the instructions to implement:
a first lookup table generator configured to generate a first lookup table corresponding to a first exponential function, based on an input scaling value;
a second lookup table generator configured to generate a second lookup table corresponding to a second exponential function, based on the input scaling value and a size of the first lookup table;
a softmax calculator configured to receive input data indicating a plurality of input values, calculate a first index of the first lookup table and a second index of the second lookup table, the first index and the second index each corresponding to a first input value of the plurality of input values, read a first exponential function value corresponding to the first index from the first lookup table, read a second exponential function value corresponding to the second index from the second lookup table, calculate a first intermediate value based on the first exponential function value and the second exponential function value, and generate output data indicating a plurality of output values respectively corresponding to the plurality of input values, wherein a first output value of the plurality of output values is generated based on the first intermediate value; and
a type converter configured to convert a data type of the output data.

20. The digital signal processing device of claim 19, wherein the first lookup table generator is further configured to:
set the size of the first lookup table to a smaller number from among: a smallest integer greater than or equal to a reciprocal number of the input scaling value, and a total amount of numbers representable using a number of bits of the first input value;
calculate the first exponential function, based on the input scaling value and the size of the first lookup table; and
generate the first lookup table having calculation results of the first exponential function as values corresponding to an index.
